(19) United States
(12) Patent Application Publication
(10) Pub. No.: US 2009/0075053 A1
(43) Pub. Date: Mar. 19, 2009

(54) Concrete Having Increased Service Life and Method of Making

(75) Inventors: Dale P. Bentz, Frederick, MD (US); Kenneth A. Snyder, Gaithersburg, MD (US)

Correspondence Address: Steve Witters, PLLC, 930 Woodland Ridge Circle, LaGrange, KY, 40031, US

(73) Assignees: GOVERNMENT OF THE UNITED STATES OF AMERICA, AS; REPRESENTED BY THE SECRETARY OF COMMERCE, THE NATIONAL INSTITUTE OF STANDARDS AND TECHNOLOGY

(21) Appl. No.: 12/206,854

(22) Filed: Sep. 9, 2008

Related U.S. Application Data
(60) Provisional application No. 60/973,561, filed on Sep. 19, 2007.

(51) Int. Cl. B32B 13/00; B32B 13/06; C04B 38/00

(52) U.S. Cl. 428/305.5; 106/672

(57) ABSTRACT

A concrete material having an extended service life and a process of making is herein provided. The concrete material has at least one organic water soluble diffusive transport modifying material that decreases the diffusivity of deleterious species through a pore solution within the concrete matrix. A process for making the concrete provides a variety of methods of introduction of the at least one organic water soluble diffusive transport modifying material into the pore solution of the concrete. The at least one organic water soluble diffusive transport modifying material may be added directly into a wet mix; the concrete may be cured in a solution having the transport modifying material; the transport modifying material may be mixed with a porous aggregate prior to adding to a wet concrete mixture; and the at least one transport modifying material may be introduced into the pore solution with a combination of these methods.

### FIELD

Aspects of the present invention generally relate to concrete having increased service life, more specifically toward admixtures and methods of making concrete that increase the concrete's resistance against deleterious species in an external environment.

### BACKGROUND

As reflected in the patent literature, cementitious composites have been used widely for external wall materials of buildings and structural elements of infrastructure construction since they provide a cement hardened construction material having strength and durability. Examples of such compositions include cementitious grout prepared by adding water to a cementing agent, mortar prepared by admixing fine aggregate (i.e. sand), therewith, and concrete prepared by further admixing coarse aggregate (i.e. gravel or stone) therewith. In general, to improve the air entrainment and fluidity for workability, chemical and mineral admixtures have been added.

Cementitious grout, mortar, and concrete (herein after referred to as “concrete”) are a mixture of fine and/or coarse aggregate that is bound together by a cementing agent. The purpose of the cementing agent is to coat the aggregate particles and to act as a matrix that bonds the aggregates into a monolithic product. Hydraulic cements harden by the chemical reaction of hydration and common examples thereof include ordinary Portland cement, limestone, gypsum plaster, lime, ground granulated blast furnace slag, pulverized fuel ash, and pozzolanic materials. The essential binding component formed when the cement hardens upon addition of water is typically calcium silicate hydrate.

Typical functions of the concrete chemical and mineral admixtures are to assure sufficient short-term and/or long-term performance criteria. Admixtures may be added to improve cement dispersion when the water content is decreased, to retain the fluidity and workability of the concrete during placement, and to improve the long-term durability and strength.

Concrete is typically made by a process of mixing a cementing agent, aggregate, and liquid water to produce a wet mixture and then allowing the cementing agent to react with water by assuring the continuous availability of water (curing). Often times the wet mixture is poured into a form or mold having steel reinforcing bars (i.e. rebar) or other reinforcing materials as are known in the art. The cured or hardened concrete is porous, having a pore volume of about 5% to about 15%, for example. This concrete may be permeable to deleterious elements in an external environment that may degrade the hardened concrete and/or corrode the steel reinforcing bars, reducing the service life of the concrete.

Our nation's infrastructure and the containment of nuclear waste are two of the more prominent examples of the application of structural concretes where an extended service life is very advantageous. Concrete structures are typically susceptible to attack by deleterious species in the external environment, such as chloride and sulfate ions, for example. This is exacerbated when constructing along the coast and in road and bridge construction where the external environmental may have elevated levels of salts or other deleterious species. These deleterious species may enter the concrete by diffusion through the concrete pore volume. Past attempts to increase service life have generally focused on limiting the ingress of these deleterious species by producing a less permeable concrete by lowering the water-to-cementitious material ratios (w/cm) and adding fine pozzolans such as silica fume that contribute to make a more dense cement paste matrix resulting in a less porous concrete. However, these mixture modifications also typically contribute to an increased temperature rise during curing and increased autogenous shrinkage, both of which increase the concrete's propensity to undergo early-age cracking, compromising the service life of the concrete.

What is needed is a concrete having an increased service life and methods of making.

### SUMMARY

According to one aspect of the present invention, a process of making concrete having an increased service life is provided. The concrete may be made by mixing at least one organic water soluble diffusive transport modifying material with water, at least one cementing agent and at least one aggregate to form a wet mixture. The at least one organic water soluble diffusive transport modifying material may be present in the wet mixture in an amount sufficient to increase the viscosity of the water portion by at least 25%. The wet mixture is then cured forming concrete having pores containing a pore solution. The pore solution may have an amount of the at least one water soluble diffusive transport modifying material suitable to reduce an ion diffusivity coefficient of the pore solution, advantageously by at least 20%.

In another aspect of the present invention, a structural concrete material is provided having an extended service life. The concrete comprises at least one aggregate, water, at least one cementing agent, and at least one organic water soluble diffusive transport modifying material. The at least one organic water soluble diffusive transport modifying material may have a molecular weight of at most 1,000 g/mol and may be present in a pore solution in the structural concrete at a concentration suitable for reducing electrical conductivity of a 0.1 mol KCl/kg water solution by about at least 20%.

In yet another aspect of the present invention, a process for making concrete is provided where porous lightweight aggregate is mixed with at least one organic water soluble diffusive transport modifying material providing pre-wetted aggregate material. The pre-wetted aggregate material may then be mixed with water, optionally other nonporous aggregate materials, and at least one cementing agent forming a wet concrete mixture. The wet concrete mixture is then cured.

These and other features, aspects and advantages of the present invention will become better understood with reference to the following drawings, description and claims.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific aspects only. In other cases it will be recognized that references to the “invention” will refer to subject matter recited in one or more, but not necessarily all, of the claims. Each of the inventions is described in greater detail below, including specific aspects, versions and examples, but the inventions are not limited to these aspects, versions or examples, which are included to enable a person having ordinary skill in the art to make and use the inventions when the information in this patent is combined with available information and technology.

Various terms as used herein. To the extent a term used in a claim is not defined herein, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable and any ranges shall include iterative ranges falling within the expressly stated ranges or limitations.

While approaches for increasing the service life of concrete structures in the prior art have focused on producing a more impermeable matrix by reductions in water-to-cementitious materials ratio and the addition of fine particles such as silica fume, in an approach of an aspect of the present invention, focus is placed on the physical properties of the pore solution in the concrete matrix through which diffusive transport of deleterious elements from an external environment occurs. Examples of such deleterious ions include chlorides, sulfates, and other ions or deleterious species known in the art that may attack the concrete matrix and/or structural support materials therein. Examples of such environments having elevated levels of deleterious species include roads, bridges, and costal structures.

Aspects of the invention generally include concrete having an extended service life and methods of making the same. Nano-sized organic water soluble diffusive transport modifying materials may be used to decrease ion diffusion coefficients in a pore solution within pores in the cured concrete. Cured concrete may have in the range of about 5% to 15% pore volume, and even more, and may have a pore solution trapped within the pores. A reduction in the diffusivity of deleterious ions such as chloride and sulfate ions within the pore solution may increase the service life of the concrete.

A reduction of the ion diffusion coefficients within the pore solution may reduce the rate of concrete material degradation by impeding the diffusion of ions such as sulfates that may react with the mineral phases within the concrete composite matrix or aggregates and thereby degrade the concrete element. Additionally, reduction of the ion diffusion coefficients within the pore solution may also reduce degradation of the concrete material by impeding the diffusion of ions such as chlorides that may degrade any structural steel that may be encased within structural concrete. The selection of the organic water soluble diffusive transport modifying material(s) may be based on effects on electrical conductivity of an ionic solution, size or molecular weight, and/or effects on pore solution viscosity.

Typically, hardened concrete can have a substantial amount of pore volume therein. The pore volume may be about 5% to 15%, or even up to 30%, for example. Within the individual pores, an amount of water may be trapped therein, forming a pore solution. The pore solution contains ions dissolved from the cementing material and the pores typically provide a pathway for the ingress of deleterious elements from the external environment. In one or more aspects of the present invention, the diffusivity properties of the pore solution may be lowered, resulting in a concrete material having decreased diffusion rates of the deleterious elements within the concrete matrix.

In one or more aspects of the present invention, at least one organic nano-sized water soluble diffusive transport modifier is added to the water, aggregate(s), cementing agent(s), and other optional additives making up a wet concrete mixture. The diffusive transport modifier(s) may be one or more organic water soluble material(s) which has a substantial portion remaining in the pore solution within the matrix of the concrete after hydration.

An understanding of the selection criteria of the diffusive transport modifier(s) to reduce the ion mobilities (diffusion) within a pore solution is gained by considering the motion of the ions at the molecular level. The motion of an individual ion in the pore solution is characterized by the particle mobility μ, which is the ratio of the particle velocity to the force on the particle. The Einstein relation expresses the self-diffusion coefficient D₀ of an ion as a function of its mobility μ as:

D₀=μk_{B} T

The quantities k_{B} and T are the Boltzmann constant and the thermodynamic temperature, respectively, and the product has units of energy.

The self-diffusion coefficient may be modified by altering the solvent properties. For example, for a spherical particle having radius r in a fluid (composed of much smaller particles acting as a solvent) having viscosity η₀, the self-diffusion coefficient may be represented by the Stokes-Einstein relation as:

D₀=k_{B} T/(6π η₀ r)

This relationship shows that the self-diffusion of an ion may be changed by changing the viscosity of the solvent. This relationship between the self-diffusion coefficient and the viscosity suggests that changes in the solution viscosity η may change the self-diffusion coefficient. This relationship may be expressed as:

D/D₀=η₀/η

Therefore, the self diffusion coefficient is shown to be inversely proportional to the solvent viscosity. For example, if the fluid viscosity η was increased to be twice that of its original value, η₀, the corresponding diffusion coefficient D, may decrease by a factor of two relative to its original value D₀. Thus, the service life of the concrete may be increased by increasing the viscosity of the pore solution since a substantial amount of the diffusion is through the pore solution of the concrete. However, this effect may only be valid where the Stokes equation applies: diffusing particles in a fluid composed of smaller (or similar size) particles. A limitation on size or molecular weight of the diffusive transport modifier is shown to be a boundary between changing the bulk viscosity and changing the solvent viscosity. For the diffusing ions relevant to typical concrete degradation mechanisms, it is shown herein that this boundary may be at a molecular weight of about 1,000 g/mol.

An additional understanding of the selection criteria of the diffusive transport modifier to reduce the ion mobilities within a pore solution is gained by considering electrical conduction. In electrical conduction, the electrophoretic mobility μₑ is the ratio of the ion drift velocity v_{d} and the applied electric field E (μₑ=eμ, where e is the charge of an electron). This shows that there may be a fundamental similarity between diffusion coefficients and electrical conductivity, at the molecular scale. Therefore, the relative effect on diffusion may be inferred from the relative effect upon the electrical conductivity. This similarity serves as a basis for estimating diffusion coefficients from electrical migration (applied electric field) tests, such as ASTM C 1202.

There are many materials in the prior art that are used to change the bulk viscosity of a wet concrete mixture. These materials have been typically used for applying mortar to vertical surfaces and in self-consolidating concretes. These viscosity modifiers, however, are typically composed of large molecules, potentially violating the applicability of the Stokes relation and therefore may not be suitable for extending the service life of the concrete.

Taken together, these phenomena suggest an inverse proportion of conductivity with viscosity for smaller molecules and the direct proportion of diffusivity with conductivity. This provides a basis for an initial screening in the selection of diffusive transport modifiers. Advantageously, selected diffusive transport modifiers of aspects of the present invention are water soluble organic materials having a molecular weight less than about 1,000 g/mol. More advantageously, selected diffusive transport modifiers of aspects of the present invention are water soluble organic materials which exhibit a reduction in electrical conductivity of a 0.1 mol KCl/kg water solution by about at least 20%. Most advantageously, selected diffusive transport modifiers of aspects of the present invention are water soluble organic materials that achieve an increase in solution viscosity of at least about 1.25× that of distilled water. However, other practical considerations should be considered in methods of making aspects of the modified concrete of the present invention.

When introducing chemical admixtures into a wet concrete mixture, either a retardation of cement hydration may occur or an exothermic reaction during curing may cause the temperature of the concrete to be excessive, causing cracking. This characteristic of some diffusive transport modifiers may make them inadequate for use in larger masses of concrete typically used in construction, i.e. structural concrete. However, alternative methods for making the diffusive transport modified concrete may be used to curb excessive retardation (or acceleration) of the cement hydration reactions thus enabling the application of such diffusive transport modifiers.

Another aspect of the present invention comprises a conventional method of making concrete where the aggregate(s), water, cementing agent(s), and diffusive transport modifier(s) are all mixed to form the wet concrete mixture. The diffusive transport modifier(s) may be pre-mixed into the mixing water prior to the mixing of the concrete or added directly to the concrete mixer. However, since concretes absorb external curing solutions during their hydration (due to the chemical shrinkage that accompanies the hydration reactions), an alternative delivery may be used.

Another aspect of the present invention uses a topical curing solution that contains the diffusive transport modifier(s) for delivery into the concrete. While the penetration depth of the admixture may be limited by the permeation properties, sorptivity and permeability, of the concrete, this delivery route may offer an advantage over admixing directly into the wet concrete mixture when the viscosity modifier has significant detrimental influences on the cement hydration reactions (such as retarding effects) or the fresh concrete properties, such as air entrainment or detrainment.

In yet another aspect of the present invention, porous lightweight aggregates (LWA) are saturated with a concentrated solution of the diffusive transport modifier(s) prior to their incorporation into a wet concrete mixture. As the cement hydrates, this internal curing solution may be drawn from the larger pores in the LWA into the smaller pores in the hydrating cement paste matrix, uniformly distributing the diffusive transport modifier(s) throughout the pore solution in the concrete.

### EXAMPLES

### Example 1

Potential diffusive transport modifiers were initially screened. Size (i.e. molecular weight) and effects on the viscosity of water as well as effects on electrical conductivity of an ion solution were then evaluated for selection for further testing to determine the effectiveness as a diffusive transport modifier. The results of this initial screening are shown in Table 1.

Solution bulk viscosities were measured using a Cannon-Fenske Routine viscometer in which the time needed for the solution to flow between two marker lines was measured; all viscosity measurements were estimated to less than 1% uncertainty. Solutions having various concentrations were prepared, as necessary, to achieve an increase in solution viscosity ranging from about 1.4× to about 3.3× that of distilled water (i.e. η_{water}/ηₛₒₗᵤₜᵢₒₙ≈0.30-0.71).

The electrical conductivity of the aqueous solutions was determined using a conductivity cell having a diameter of 25 mm and an electrode separation of 150 mm (the cell constant was 0.31455±0.00010 mm⁻¹). The cell was calibrated using standard potassium chloride (KCl) solutions, and all conductivity values were estimated to less than 1% uncertainty. KCl was selected to serve as a chloride “invader” or deleterious species to the aqueous diffusive modified solutions, acting as a surrogate cementitious pore solution. These diffusive modifier solutions were first prepared and then KCl was added to the solutions at a concentration of 0.100 mol/kg. The resulting bulk electrical conductivities were compared to those of KCl solutions in distilled water at the same concentration.

TABLE 1

| | | | | Electrical |
|---|---|---|---|---|
| | | | | Conductivity |
| | | | | Reduction Factor for |
| | | | | KCl/Modifier |
| | | | | Solutions vs. |
| | | | | KCl/Distilled Water |
| | | Concentration | | Solutions (moles of |
| | | Wt. % (Mass | | chloride ion per unit |
| Potential Diffusive | Molecular | additive/mass | η_{water}/ | mass of solution) |
| Transport Modifier | Weight | water) | ηₛₒₗᵤₜᵢₒₙ | 0.1 mol/kg |
| Xanthum Gum | ≈1,000,000 | 0.4 | 0.43 | 1.00 |
| Cellulose Ether | ≈100,00 | 0.29 | 0.30 | 0.98 |
| Polyvinyl alcohol | ≈10,000 | 2 | 0.58 | 0.98 |
| Polyoxyalkylene alkyl ether | ≈400-1,000 | 11 | 0.67 | 0.67 |
| Polyoxyalkylene alkyl ether | ≈400-1,000 | 25 | 0.39 | 0.47 |
| Polyethylene Glycol 600 | ≈600 | 18 | 0.52 | 0.67 |
| Polyethylene Glycol 400 | ≈400 | 25 | 0.44 | 0.56 |
| Polypropylene Glycol P400 | ≈400 | 11 | 0.66 | 0.75 |
| DOW PT 250 Polyglycol | ≈250 | 11 | 0.70 | 0.77 |
| Dipropylene glycol/Propanol, | ≈134/90 | 11 | 0.72 | 0.76 |
| [2-,1- | | | | |
| dimethylethoxy)methylethoxy] | | | | |
| Glycerol | ≈92.1 | 43 | 0.48 | 0.49 |

As shown in Table 1, a general trend is that the larger the molecular mass of the modifier, the lower the concentration required to increase the viscosity of distilled water. If increasing the bulk viscosity were an objective of the present invention, large molecules such as cellulose ethers, xanthum gum, and polyvinyl alcohol would clearly provide the most cost efficient means. However, an objective of aspects of the present invention is to decrease the diffusivity rate of deleterious species in a concrete pore solution. Diffusivity is estimated by conductivity in the initial screening since a decrease in conductivity may provide a decrease in ion mobility.

Table 1 shows that some of the materials initially screened for application as a diffusive transport modifier are effective in reducing the solution conductivities, while others have little or almost no measurable effect on conductivity. The larger molecules such as cellulose ether, xanthum gum, and polyvinyl alcohol were shown to have almost no influence on conductivity within the solutions despite their measurable effects on bulk viscosity. Conversely, the smaller nano-sized molecules having a molecular weight less than 1,000 g/mol were shown to be effective in reducing conductivity. Therefore, aspects of the present invention have a diffusive modifier with a molecular weight of at most 1,000 g/mol.

### Example 2

Based on the results of Example 1, polyoxyalkylene alkyl ether was selected for use as diffusive transport modifier in a series of mortars with a water-to-cement ratio (w/c) of 0.4. The diffusive transport modifier was added at a concentration of about 10% (of total solution mass), which provided a viscosity increase of 1.5× in distilled water as shown in Table 1. Three methods were employed for delivering the diffusive transport modifier into the mortars, and are described schematically in Table 2 for each method and its corresponding control. The first method comprised the conventional method of making concrete where the aggregate(s), water, cementing agent(s), and diffusive transport modifier(s) are all mixed to form the wet concrete mixture. The second method included a topical curing solution that contained the diffusive transport modifier for delivery into the concrete. The third method used porous fine lightweight aggregates (LWA) saturated with a concentrated solution of the diffusive transport modifier prior to incorporation into the wet concrete mixture.

TABLE 2

| | Organic Water Soluble Diffusive | | |
|---|---|---|---|
| | Transport Modifier Application | | |
| | | | Admixture- |
| | Wet Concrete | | Saturated Porous |
| Method | Mixture | Surface Application | Aggregate |
| 1/Control | YES/NO | NO | NO |
| 2/Control | YES/NO | YES/YES | NO |
| 3/Control | NO | NO | YES/NO |

Wet mixtures were prepared by each method and a control sample was also prepared by each method for comparison. The wet mixtures were placed into cylindrical molds having a 50 mm diameter and a 100 mm length (about 2″×4″) and allowed to cure for 1 day, forming concrete cylinders. Concrete cylinders having polyoxyalkylene alkyl ether prepared by the first method and concrete cylinders prepared as a control having no polyoxyalkylene alkyl ether, were further cured for a total of 7 days and 28 days.

Concrete cylinders were prepared by the second method, with and without polyoxyalkylene alkyl ether in the wet mixture. After curing for one day, the cylinders were further cured in polyoxyalkylene alkyl ether solutions for a total cure time of 7 days and 28 days. The second method and its control cylinders were both cured in a solution of 1.1% NaOH/KOH/Ca(OH)₂ and 11% polyoxyalkylene alkyl ether.

The concrete cylinders prepared by the third method were cured in sealed double plastic bags for a total cure time of 7 and 28 days. These concrete cylinders were prepared by pre-wetting the dry lightweight aggregates with a 50% solution of polyoxyalkylene alkyl ether in water prior to adding to the wet mixture that was placed into the mold. The control cylinders of the third method were prepared by pre-wetting the dry lightweight aggregates with water only prior to adding to the wet mixture that was placed into the mold. The replacement of normal weight sand by lightweight aggregates in the mortar was done in an amount to achieve the same overall addition rate of the polyoxyalkylene alkyl ether, approximately 10%, as that used in the other mortars prepared by the first and second methods.

After curing for 7 days and 28 days, each concrete cylinder was placed into individual sealable plastic bottles containing sufficient 1 mol/L sodium chloride solution to submerge the specimen. Chloride ion ingress into the mortar cylinders after exposure times of 28 days, 56 days, and 180 days for each cylinder and associated blank was measured. At each exposure time, two cylinders of each type were removed from their chloride solutions and broken down the middle (lengthwise) using the split-cylinder configuration on a universal testing machine. For each specimen, one of the two created faces was sprayed with silver nitrate (AgNO3) and an image processing software was used to assess the penetration depth of the chloride ions. As of the drafting of this application, exposures through 180 days have been completed. The results obtained as of the drafting of this application with respect to the penetration depths are shown in Table 3.

TABLE 3

| | days cured prior to Cl⁻ exposure | | |
|---|---|---|---|
| | 28 days Cl⁻ | 56 days Cl⁻ | |
| | exposure, | exposure, | 180 days Cl⁻ |
| Sample, | mm | mm | exposure, mm |
| Description | penetration | penetration | penetration |
| 1ac, Control Method 1/7 | 6.68 | 6.27 | 7.29 |
| 1a, Method 1/7 | 4.75 | 5.57 | 7.38 |
| 2ac, Control Method 2/7 | 5.97 | 5.44 | 7.51 |
| 2a, Method 2/7 | 5.37 | 5.28 | 7.28 |
| 3ac, Control Method 3/7 | 5.01 | 5.26 | |
| 3a, Method 3/7 | 4.42 | 3.64 | 5.74 |
| 1bc, Control Method 1/28 | 5.06 | 5.11 | 7.66 |
| 1b, Method 1/28 | 4.43 | 4.71 | 7.03 |
| 2bc, Control Method 2/28 | 4.69 | 5.23 | 7.41 |
| 2b, Method 2/28 | 4.38 | 4.2 | 6.15 |
| 3bc, Control Method 3/28 | 3.67 | 4.36 | |
| 3b, Method 3/28 | 3.33 | 3.72 | |

As shown in Table 3, systems employing polyoxyalkylene alkyl ether are shown to unexpectedly exhibit reduction in chloride ion penetration depth. Sample 1a had polyoxyalkylene alkyl ether employed by the first method and sample 1ac was the control prepared by the first method having no polyoxyalkylene alkyl ether, both of which were cured for a total of 7 days prior to contact with the Cl⁻ solution. The depth of penetration of Cl⁻ in sample 1a was reduced by more than 25% as compared to control sample 1ac after 28 days of exposure. However, this reduction in Cl⁻ penetration is not observed after 180 days of Cl⁻ exposure. Cl⁻ penetration will be monitored for up to 365 days as this data point may be an outlier.

Samples 2a and 2ac show that the introduction of polyoxyalkylene alkyl ether into the wet mixture for concrete cylinders that are also exposed to the polyoxyalkylene alkyl ether during a 7 day cure improves the resistance to Cl⁻ penetration slightly, after 180 days, as compared to only exposing the cylinder to the polyoxyalkylene alkyl ether during the 7 day cure. Sample 2a had polyoxyalkylene alkyl ether in the wet mixture and was cured for 7 days in a solution of 1.1% NaOH/KOH/Ca(OH)₂ and 11% polyoxyalkylene alkyl ether. Sample 2ac, the control sample made by method 2, had no polyoxyalkylene alkyl ether in the wet mixture but was cured in a solution of 1.1% NaOH/KOH/Ca(OH)₂ and 11% polyoxyalkylene alkyl ether.

Sample 3a shows that the introduction of polyoxyalkylene alkyl ether by pre-wetting the dry lightweight aggregates with a 50% solution of polyoxyalkylene alkyl ether in water prior to adding to the wet mixture substantially improves the resistance of Cl⁻ diffusivity after 180 days. This sample was cured for 7 days and unexpectedly exhibited over a 33% reduction in Cl⁻ penetration as compared to sample lac, having no polyoxyalkylene alkyl ether. Results of the control, sample 3ac, for the 180 day exposure were not yet available. However, the data shown in Table 3 indicates that this may be an advantageous method of introducing a diffusive transport modifier into concrete.

Sample 1b has polyoxyalkylene alkyl ether employed by the first method and sample 1bc is the control prepared by the first method having no polyoxyalkylene alkyl ether, both of which were cured for a total of 28 days prior to contact with the Cl⁻ solution. The depth of penetration of Cl⁻ in sample 1b was reduced by more than 8% as compared to control sample 1ac after 180 days of exposure. This shows that the diffusive transport modifier unexpectedly retains the characteristic of decreasing ion diffusivity in the pore solution for a longer period of time as compared to the sample 1a, cured for a shorter period of time, 7 days.

Samples 2b and 2bc show that the introduction of polyoxyalkylene alkyl ether into the wet concrete mixture, for concrete cylinders cured for 28 days in a solution of 1.1% NaOH/KOH/Ca(OH)₂ and 11% polyoxyalkylene alkyl ether, improves the resistance to Cl⁻ penetration by about 17%, after 180 days. Sample 2bc had no polyoxyalkylene alkyl ether in the wet mixture but was cured for 28 days in a solution of 1.1% NaOH/KOH/Ca(OH)₂ and 11% polyoxyalkylene alkyl ether. Sample 2b had polyoxyalkylene alkyl ether in the wet mixture and was cured in a solution of 1.1% NaOH/KOH/Ca(OH)₂ and 11% polyoxyalkylene alkyl ether for 28 days.

Sample 3b shows that the introduction of polyoxyalkylene alkyl ether by pre-wetting the dry lightweight aggregates with a 50% solution of polyoxyalkylene alkyl ether in water prior to adding to the wet mixture improved the resistance to Cl⁻ penetration after 56 days of contact time by about 15% as compared to control sample 3bc. Sample 3bc was prepared by first wetting the dry lightweight aggregate with water. Samples 3b and 3bc were cured for 28 days prior to being contacted with the Cl⁻ solution. The data in Table 3 shows that this may be an advantageous method of introducing a diffusive transport modifier into concrete.

As shown in Table 3, the measured penetration depths are significantly less for the samples that were first cured for 28 days, as compared to 7 days, before being exposed to the chloride ion solution. This may be due to the additional hydration achieved between 7 days and 28 days further densifying the mortar microstructure and reducing both its porosity and pore solution connectivity. For the samples cured for 7 days before chloride ion exposure, the penetration depths achieved after either 28 days or 56 days are fairly similar and in some cases, the penetration depth achieved after 56 days is slightly less than that after 28 days. This may be because the samples that only cured for 7 days undergo additional hydration during their chloride ion exposure period. Continuing hydration may lead to reductions in capillary porosity (water) that may locally increase the concentration of chloride ions, reducing or perhaps even removing the concentration gradient that is driving the diffusion. Conversely, for the samples cured for 28 days, where the hydration is much more complete, a trend of an increasing penetration depth with exposure time was generally observed.

The diffusive transport modifiers of aspects of the present invention are shown to decrease the diffusion rates of ingressing ions such as chlorides. Even though only chloride penetration was tested in the examples, other ions such as sulfates and other deleterious species as are known in the art may also exhibit decreased diffusion rates. An increase of the viscosity of the pore solution may also reduce other modes of ingress from the external environment into the concrete, such as sorption and flow under pressure (permeation). While an increase in viscosity may not change the permeability coefficient of the concrete microstructure, the flow rate of a fluid within the concrete due to a pressure gradient may be inversely proportional to the viscosity of the flowing fluid. Additionally, the sorptivity coefficient of a porous material may be proportional to one over the square root of the solution viscosity. Therefore, a higher viscosity may yield a lower sorption rate, during wet/dry cycling, for example. This assumes that the admixture may precipitate and redissolve during wet/dry cycling, as supported by experimental data in Table 3. Thus, the advantages provided by the addition of diffusive transport modifiers with respect to diffusion may also be present for flow under pressure and for sorption, two of the other common mechanisms of transport into and through concrete.

It is anticipated that concentrations of diffusive transport modifiers in the wet concrete mixture as low as 5% by weight (mass additive/mass water) will have the desired effect of increasing service life of concrete. However, in an advantageous aspect of the present invention, diffusive transport modifiers are incorporated into the wet concrete mixture at a concentration of at least 7.5% by weight, and more advantageously the concentration is at least 10% by weight. Additionally, the diffusive transport modifier may be comprised of a combination of constituents that exhibit the desired properties and effects.

It should be understood that the foregoing relates to exemplary aspects of the invention and that modifications may be made without departing from the spirit and scope of the invention as set forth in the following claims.

1. A process of making concrete having an increased service life comprising:
providing at least one organic water soluble diffusive transport modifying material;
mixing said at least one organic water soluble diffusive transport modifying material with water, at least one cementing agent, and at least one aggregate to form a wet mixture, said at least one organic water soluble diffusive transport modifying material being present in an amount sufficient to increase the viscosity of water by at least 25%; and
curing said wet mixture forming concrete having pores containing a pore solution;
said pore solution having an amount of said at least one water soluble diffusive transport modifying material suitable to reduce the ion diffusivity coefficient by at least 20%.

2. The process of claim 1 wherein said at least one organic water soluble diffusive transport modifying material has a molecular weight of at most 1,000 g/mol.

3. The process of claim 1 wherein said wet mixture has more than 5% by weight of said at least one organic water soluble diffusive transport modifying material.

4. The process of claim 1 wherein said pore solution has at least about 10% by weight of said at least one organic water soluble diffusive transport modifying material.

5. The process of claim 1 wherein said at least one organic water soluble diffusive transport modifying material is suitable to reduce electrical conductivity of a 0.1 mol KCl/kg water solution by about at least 20%.

6. The process of claim 1 wherein said at least one aggregate has a porous aggregate portion, said at least one water soluble diffusive transport modifying material being mixed with said porous aggregate portion prior to said step of mixing said at least one organic water soluble diffusive transport modifying material with said water, said at least one cementing agent and said at least one aggregate to form said wet mixture.

7. The process of claim 1 wherein said curing step comprises curing said wet mixture for at least 7 days prior to exposure to an external environment having elevated levels of deleterious species.

8. The process of claim 1 wherein said curing step comprises curing said wet mixture for at least 28 days prior to exposure to an external environment having elevated levels of deleterious species.

9. The process of claim 1 wherein said at least one soluble diffusive transport modifying material is suitable to resolubilize with water after a wet/dry cycle.

10. A structural concrete article made from the process of claim 1 having an increased service life of at least 20%.

11. Structural concrete having an extended service life comprising:
at least one aggregate,
water,
at least one cementing agent, and
at least one organic water soluble diffusive transport modifying material having a molecular weight of at most 1,000 g/mol and at a concentration suitable for reducing electrical conductivity of a 0.1 mol KCl/kg water solution by about at least 20% in a pore solution in said structural concrete.

12. The structural concrete of claim 11 wherein said at least one organic water soluble diffusive transport modifying material is present in said pore solution in an amount sufficient to increase the viscosity of said pore solution by at least 25%.

13. The structural concrete of claim 11 having steel reinforcing bars therein.

14. The structural concrete of claim 11 having an extended service life of at least 20% over a like comprised concrete not having said at least one organic water soluble diffusive transport modifying material when said structural concrete is exposed to an external environment having elevated levels of deleterious species.

15. A process for making concrete comprising the steps of:
mixing a porous aggregate with a solution having at least one organic water soluble diffusive transport modifying material providing a pre-wetted aggregate material;
mixing said pre-wetted aggregate material with water, normal weight coarse and fine aggregate material, and at least one cementing agent forming a wet concrete mixture;
curing said wet concrete mixture.

16. The process for making concrete of claim 15 wherein said at least one organic water soluble diffusive transport modifying material has a molecular weight of at most 1,000 g/mol.

17. The process for making concrete of claim 15 wherein said at least one organic water soluble diffusive transport modifying material is present in a pore solution in an amount suitable to reduce the ion diffusivity coefficient by at least 20%.

18. The process for making concrete of claim 15 wherein said at least one organic water soluble diffusive transport modifying material is present in a pore solution in an amount suitable to increase the viscosity by at least 25%.

19. The process for making concrete of claim 15 wherein said at least one organic water soluble diffusive transport modifying material is present in a pore solution in an amount suitable to decrease electrical conductivity of a 0.1 mol KCl/kg water solution by about at least 20%.

20. The process for making concrete of claim 15 wherein a pore solution has at least 5% by weight of said at least one organic water soluble diffusive transport modifying material.
